(19) United States
(12) Patent Application Publication
(10) Pub. No.: US 2002/0127014 A1
(43) Pub. Date: Sep. 12, 2002

(54) Fluid dispensing method and apparatus employing piezoelectric transducer

(76) Inventor: David B. Wallace, University Park, TX (US)

Correspondence Address: Dinsmore & Shohl LLP, 1900 Chemed Center, 225 East Fifth Street, Cincinnati, OH, 45202, US

(21) Appl. No.: 09/727,933

(22) Filed: Nov. 30, 2000

Related U.S. Application Data
(60) Provisional application No. 60/172,087, filed on Dec. 23, 1999.

(51) Int. Cl. G03D 3/00

(52) U.S. Cl. 396/564

(57) ABSTRACT

A fluid dispensing apparatus, for use in fluid dispensing systems for the controlled application, metering, and/or dispensing of fluid from a plurality of orifices. The apparatus comprises a body having at least one cavity, at least one fluid inlet for introducing the fluid into the cavity, and at least one fluid outlet for discharging the fluid from the cavity. A plurality of orifices are in communication with the fluid outlet and at least one piezoelectric actuator is selectively coupled to the body and operable to pressurize the fluid within the cavity and permit the controlled discharge of the fluid through the plurality of orifices onto a substrate.

This application claims the benefit of U.S. Provisional Application No. 60/172,087 filed on Dec. 23, 1999.

### FIELD OF THE INVENTION

The present invention relates, in general, to apparatus and methods for dispensing fluid. More particularly, the present invention relates to fluid dispensing apparatus and methods employing a piezoelectric transducer for the controlled application, metering, and/or dispensing of fluid droplets from a plurality of orifices.

### BACKGROUND OF THE INVENTION

A wide variety of dispensing application systems are well known in the art. The most common types of dispensing application systems include systems that utilize pressurized aerosol technology, positive displacement pumping, and inkjet technology. Discrete dispensing systems that use pressurized aerosol, for example in the airbrush format, are well known for use in coating application methods. Although these systems produce a wide range of droplet sizes, they do not allow for precise volumetric and temporal control during droplet creation. Discrete dispensing systems that use positive displacement pumping are also well known for use in coating application methods. However, these systems are typically capable of only ill resolution per channel and cycle times of one second or more.

Most inkjet systems commercially available may be generally classified as either a “continuous jet” type ink jet system where droplets are continuously ejected from the printhead or as a “drop-on-demand” type ink jet system where droplets are ejected from the printhead in response to a specific command. Continuous ink jet systems are based upon the formation of uniform droplets from a stream of liquid issuing from an orifice. In a continuous ink jet system, fluid is typically ejected under pressure from an orifice about 50 to 80 microns in diameter and tends to break up into uniform droplets upon the amplification of capillary waves induced onto the jet, for example, by an electromechanical device that causes pressure oscillations to propagate through the fluid. However, one drawback to continuous jet systems is that fluid must be jetting even when not in use. This requirement tends to degrade the fluid and decrease reliability of the system.

In a drop-on-demand fluid jet system, a volumetric change in the fluid is induced by the application of a voltage pulse to a piezoelectric material which is directly or indirectly coupled to the fluid. This volumetric change causes pressure/velocity transients to occur in the fluid and these are directed so as to produce a droplet that issues from an orifice. As is known in the art, these systems typically have individual piezoelectric transducers and electronic controllers for each orifice. However, one commercial demand-mode fluid jet printhead sold by Trident uses three orifices per actuator, extendable by only one or two orifices. As a result, when drop-on-demand systems are integrated into arrays, the complexity and cost of the systems increase substantially.

Other coating application methods include excess coat and wipe methods and premetered methods, which differ in their method of controlling the amount of coating solution applied to a substrate. In excess coating application methods, an amount of solution in excess of the desired coating weight is applied to the substrate. A scraping device then removes the excess coating material from the substrate to achieve the desired coating weight. Such methods waste a large amount of the coating material and do not provide fast temporal response and/or clean startup and shutdown.

In a pre-metered application method, the amount of coating material is accurately measured and initially applied to the substrate to achieve the desired coating weight and removal of excess coating material is not required. As known in the art, doctor blades are constrained a metered distance off of the surface of a substrate and are used for smoothing a metered amount of coating material after it is applied to the substrate surface. This method typically does not provide for recirculation of the coating solution since none of the solution applied to the substrate is removed from the substrate surface. However, when these coaters are used with lower viscosity fluids and/or lower coating weights, it becomes more difficult to maintain uniform flow velocity and uniform hydrostatic pressure across the width of the slot.

As such, improved apparatus and methods for dispensing fluid are desired. A fluid dispensing apparatus and method that provides for the controlled application, metering, and/or dispensing of fluid droplets from a plurality of orifices is desired.

### SUMMARY OF THE INVENTION

In accordance with one embodiment of the present invention there is provided a fluid dispensing apparatus. The fluid dispensing apparatus includes a body having at least one cavity, at least one fluid inlet for introducing the fluid into the cavity, and at least one fluid outlet for discharging the fluid from the cavity. A plurality of orifices are in communication with the fluid outlet and at least one piezoelectric actuator is selectively coupled to the body and operable to pressurize the fluid within the cavity and permit the controlled discharge of the fluid through the plurality of orifices.

In accordance with another embodiment of the present invention, a fluid jet printhead for applying developer to a photographic element is provided. The fluid jet printhead includes a body having at least one cavity, at least one fluid inlet for introducing the developer into the cavity, and at least one fluid outlet for discharging the developer from the cavity. A plurality of orifices are in communication with the fluid outlet and at least one piezoelectric actuator is selectively coupled to the body and operable to pressurize the developer within the cavity and permit controlled discharge of the developer through the plurality of orifices onto a photographic element.

Also provided is a method of applying developer to a photographic element. The method includes the steps of providing a source of developer fluid, a fluid cavity in communication with the fluid source, and a plurality of orifices in communication with the fluid cavity, selectively applying a voltage pulse to a piezoelectric actuator to pressurize the developer fluid within the cavity and discharge the developer fluid through the plurality of orifices, and depositing the developer fluid exiting the plurality of orifices onto a photographic element.

Accordingly, the apparatus and methods of the present invention reduce or obviate various problems and shortcomings of coating and dispensing systems heretofore available in the industry. Particularly, the apparatus and methods of the invention provide an efficient yet simple means for coating surfaces and dispensing fluids. It is a further advantage to provide improved ink jet printheads and methods that employ one or more piezoelectric actuators driving a plurality of orifices.

Still other advantages of the present invention will become apparent to those skilled in the art from the following description wherein there is shown and described alternative exemplary embodiments of this invention. As will be realized, the invention is capable of other different, obvious aspects and embodiments, all without departing from the invention. Accordingly, the drawings and descriptions should be regarded as illustrative in nature and not as restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is an exploded view of one embodiment of a fluid dispensing apparatus in accordance with the present invention;

FIG. 2 is a cross-sectional view of a schematic illustration of another embodiment of a fluid dispensing apparatus in accordance with the present invention;

FIG. 3 is a perspective view of another embodiment of an orifice array for use in the apparatus and methods of the invention; and

FIG. 4 is a perspective view of yet another embodiment of an orifice array for use in the apparatus and methods of the invention.

### DETAILED DESCRIPTION

Reference will now be made in detail to various embodiments of the present invention, examples of which are illustrated in the accompanying drawings wherein like numerals indicate the corresponding structure throughout the views. As will be understood hereafter, various embodiments of the present invention relate to improved fluid dispensing apparatus for the controlled application, metering, and/or dispensing of fluid droplets from a plurality of orifices. While the present invention is described hereafter with respect to fluid jet printheads for applying developer to a photographic element, it should be understood that the present invention can be adapted for other uses and applications of dispensing. For example, the fluid dispensing apparatus of the present invention might also be suitable for, inter alia, dispensing of drugs for pulmonary, nasal, or topical delivery; dispensing of odorants, pheromones, or other airborne chemicals to be detected by humans, animals, or instruments; application of adhesives and/or coating materials; and application of light emitting materials for display manufacturing.

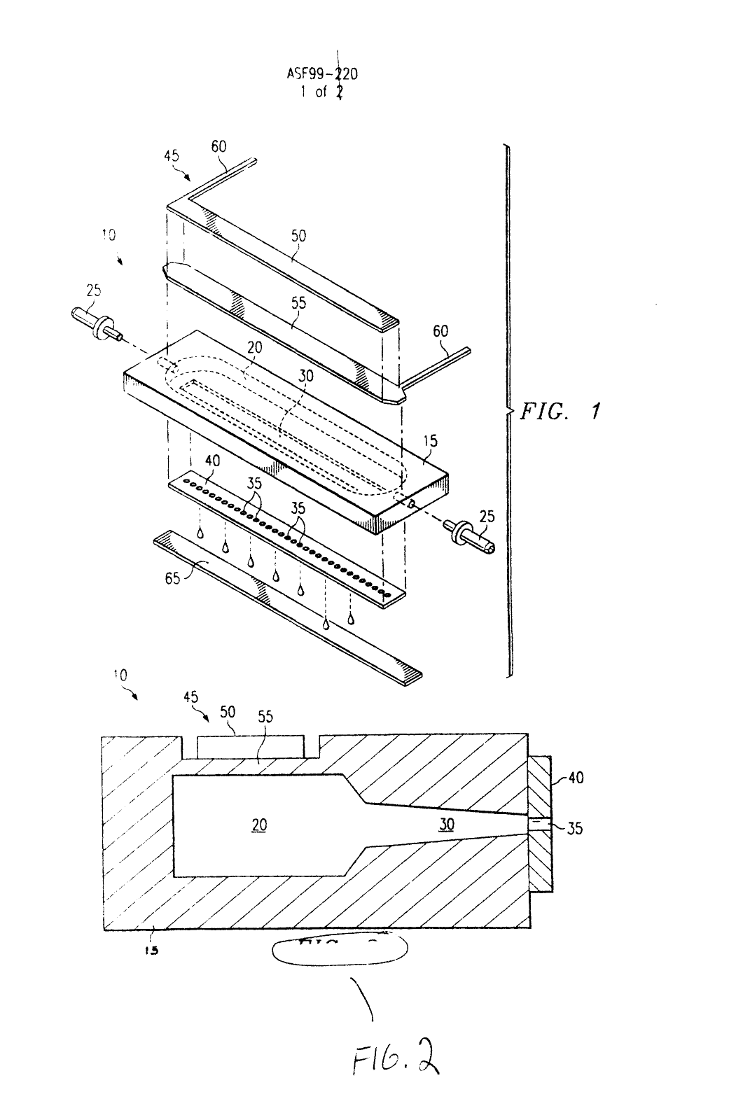

In one embodiment as shown in FIG. 1, a fluid dispensing apparatus comprises a fluid jet printhead 10 which employs an actuator driving a plurality of orifices. The fluid jet printhead 10 includes a body 15, at least one fluid inlet 25 and at least one fluid outlet 30 (shown in phantom), a plurality of orifices 35, and at least one piezoelectric actuator 45. In a preferred embodiment, the body 15 is formed of stainless steel. Examples of other suitable materials include, but are not limited to, titanium, molybdenum, and nickel. In addition, rigid plastics, such as Ryton® may be used. The body 15 has at least one cavity 20 (shown in phantom) therein where fluid is held. The cavity 20 is typically an elongated oval shape in cross section into which fluid is introduced through the at least one fluid inlet 25 and from which fluid is discharged through the at least one fluid outlet 30 (shown in phantom). However, any suitable shape can be used for the cavity 20. For example, a rectangular, triangular, or other cross-sectional shaped cavity 20 may be used. The fluid may be supplied to the cavity 20 by a pump, by gravity-feed, or by other known methods of supplying quantities of fluid to a fluid jet printhead. In addition, a fluid may be supplied to the cavity 20 via the fluid inlets 25 located at one or both ends, or at some intermediate point along the length of the cavity 20. However, as further shown in FIG. 1, the fluid jet printhead 10 preferably comprises two fluid inlets 25 located at opposite ends of the cavity 20.

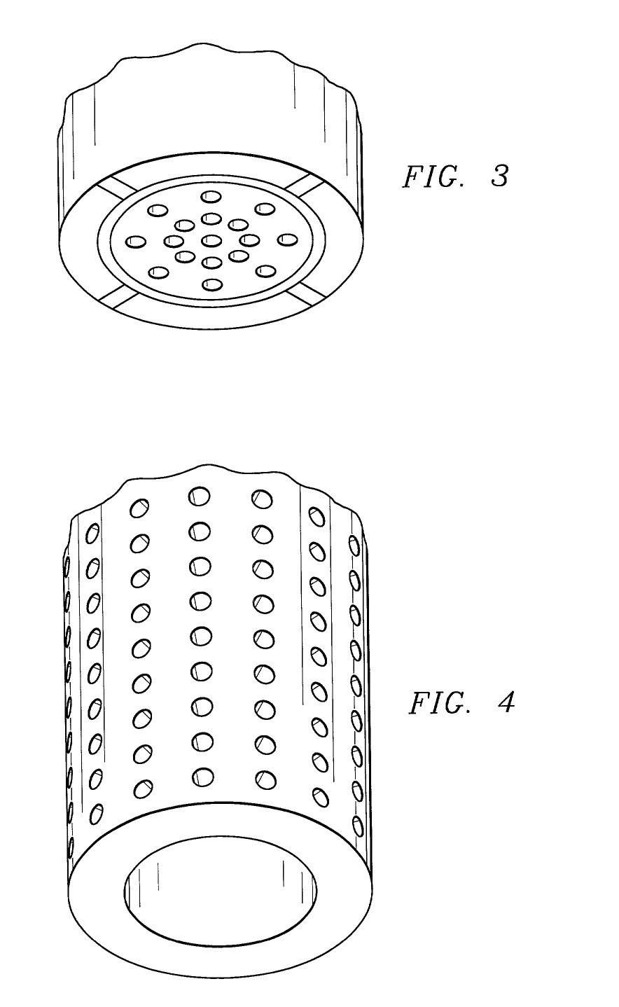

The plurality of orifices 35 are formed in an orifice plate 40 and are in communication with the fluid outlet 30. Preferably, the orifice plate 40 is formed from polymers, metal, or like materials. Preferred materials for use in forming the orifice plate include excimer laser machined polymers, such as polyamide, or electroformed nickel. However, one skilled in the art will recognize that any suitable type of precision orifice plate manufacturing method and material may be utilized to provide an appropriate orifice plate. In the embodiment shown in FIG. 1, the plurality of orifices 35 are arranged to conform to the fluid outlet 30. While any suitable fluid outlet shape may be used, the fluid outlet 30 preferably has an opening in the shape of a slot so that the plurality of orifices 35 are distributed in a linear array. Examples of alternative configurations for orifice arrays are shown in FIGS. 3 and 4. In FIG. 3, the orifice array is distributed across a flat, circular plate while in FIG. 4 the orifice array is distributed across a curved, cylindrical plate. The configurations shown in FIGS. 3 and 4 are preferable for the controlled dispensing of fluid droplets into the air.

Referring again to FIG. 1, the number of orifices 35 formed in the orifice plate 40 preferably is in the range of from about 20 to about 200, and even more preferably from about 50 to about 150. In addition, the orifices 35 are sized to produce fluid droplets preferably in the 5 μm to 250 μm range, more preferably in the 10 μm to 200 μm range, and even more preferably in the 25 μm to 100 μm range. While round orifices are preferred, orifices of other shapes, such as oval, triangular, and pentagonal, may be used, if desired. Preferably, orifices are sized to produce droplets having the above-mentioned preferred diameters. It should be noted that while the preferred location, configuration, number and size of the orifices have been described above, these arrangements may be varied depending on the desired application. Also, it should be further noted that the size and number of orifices are limited by actuator and electronic driver considerations.

The at least one piezoelectric actuator 45 is selectively coupled to the body 15 and operable in order to pressurize the fluid within the cavity 20 and permit the controlled discharge of the fluid through the plurality of orifices 35. As shown in FIG. 1, the piezoelectric actuator 45 is a bend-mode piezoelectrically driven type actuator. However, one skilled in the art would recognize that additional actuators could also be used with equal facility, such as squeeze-tube actuators, push-mode actuators, and shear-mode actuators.

Preferably, the piezoelectric actuator 45 is comprised of a piezoelectric material 50 bonded to a diaphragm 55. The diaphragm may suitably be formed of metal. Additionally, it is preferable that the diaphragm 55 is comprised of stainless steel. Examples of other suitable metals include, but are not limited to, aluminum, titanium, molybdenum, and nickel. Typically, the diaphragm 55 has a thickness of from about 100 μm to about 500 μm and a width of from about 3 mm to about 15 mm. In a preferred embodiment as shown in FIG. 1, the piezoelectric material 50 is a lead-zirconium-titanium oxide, for example, lead zirconate titanate or PZT. In further embodiments, the piezoelectric material 50 may be comprised of, for example, electrorestrictive materials, such as lead metaniobate or magnitostrictive materials, such as Terphanol. Typically, the piezoelectric material 50 has a thickness of from about 50 μm to about 250 μm. Also, the piezoelectric material 50 is metalized on both sides. As such, when a voltage pulse is applied across the piezoelectric material 50 via an electronic driver (not shown), the piezoelectric material 50 will readily bend or deform. In addition, the piezoelectric material 50 is preferably sized so that the actuator 45 is approximately as long as orifice plate 40.

In operation, fluid dispensing apparatus or fluid jet printhead 10, as shown in FIG. 1, is supplied with fluid from a fluid supply or reservoir (not shown). An electronic drive circuit (not shown) applies a voltage pulse via leads 60 to the piezoelectric actuator 45. In response, the piezoelectric material 50 of the actuator 45 will tend to increase in thickness and decrease in width. Because piezoelectric material 50 is constrained by diaphragm 55, the actuator 45 is displaced in a manner that reduces the volume in the cavity 20 and consequently increases the pressure of the fluid contained within cavity 20. The fluid in cavity 20 receives the energy from actuator 45 and is transmitted to the fluid outlet 30 in the form of pressure waves, such that a droplet of fluid is forcibly discharged from the plurality of orifices 35. However, because the direction of travel of these pressure waves does not determine the direction of travel of the droplets that are eventually formed, the actuator 45 can be located relative to the cavity 20 in various manners.

In the preferred embodiment illustrated in FIG. 1, the direction of motion of actuator 45 is substantially parallel to the plane of orifice plate 40. This embodiment minimizes the size of the fluid jet printhead 10 in the direction parallel to the flight path of the fluid droplets.

In another embodiment schematically illustrated in FIG. 2, the fluid jet printhead 10 includes a body 15, at least one fluid inlet (not shown), at least one fluid outlet 30, a plurality of orifices 35, orifice plate 40, and at least one piezoelectric actuator 45. Additionally, the piezoelectric actuator 45 illustrated in FIG. 2 is comprised of a piezoelectric material 50 bonded to a diaphragm 55. In the embodiment shown in FIG. 2, the direction of motion of the actuator 45 is substantially normal to the plane of the orifice plate 40. As a result, the size of the fluid jet printhead 10 is minimized in the direction normal to the flight path of the fluid droplets.

The embodiments illustrated in FIGS. 1 and 2 are preferable for the controlled application of fluid onto substrates. For example, it has been found that a particular application of the fluid dispensing apparatus or fluid jet head 10 such as illustrated in FIGS. 1 and 2, can deliver temporal control of greater than or equal to about 5 μs, preferably greater than about 10 μs, at flow rates of less than or equal to about 200 μl/s, preferably less than 100 μl/s, while still maintaining linear coverage up to about 100 mm for a single printhead. Linear coverage describes the formation of a uniform line of fluid on a substrate. Examples of suitable substrates include, but are not limited to, paper, polymer, and metal substrates. The substrate may be in sheet or film form, or may comprise a more diverse shape. In a preferred embodiment, the substrate comprises a recording medium such as paper, film, or other light sensitive media.

In alternative embodiments of the fluid dispensing apparatus or fluid jet printhead, the body comprises a plurality of the cavities and a plurality of the piezoelectric actuators, wherein at least one of the plurality of actuators is selectively coupled to the body and operable to pressurize the fluid within each cavity. In such embodiments, multiple fluids, for example developers, modifiers, inks, adhesives, antibodies, DNA, albumin, polymers, conductive polymers, nanoparticle suspensions, and optical filter materials, could be dispensed from a single apparatus during multiple passes.

As shown in FIG. 1, a preferred method according to the invention is directed to application of developer to a photographic element. A source of developer fluid, a fluid cavity 20, a plurality of orifices 35, and at least one piezoelectric actuator 45 are provided. The cavity 20 is in communication with the fluid source, the plurality of orifices 35 are in communication with the cavity 20. An electronic drive circuit selectively applies a voltage pulse via leads 60 to the actuator 45 to pressurize a developer within the cavity 20 whereby droplets of developer are forcibly discharged from the plurality of orifices 35. Finally, the droplets exiting the plurality of orifices 35 are deposited onto a photographic element 65, such as film, paper, or other light sensitive media.

Having shown and described the preferred embodiments of the present invention, further adaptations of the methods and apparatus described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of structure and operation shown and described in the specification and drawings.

What is claimed is:

1. A fluid dispensing apparatus comprising:
a body having at least one cavity therein;
at least one fluid inlet for introducing a fluid into the cavity and at least one fluid outlet for discharging a fluid from the cavity;
a plurality of orifices in communication with the fluid outlet; and
at least one piezoelectric actuator selectively coupled to the body and operable to pressurize the fluid within the cavity and permit controlled discharge of the fluid through the plurality of orifices.

2. The apparatus according to claim 1, wherein the actuator comprises a piezoelectric material bonded to a diaphragm.

3. The apparatus according to claim 2, wherein the actuator is displaced in a direction substantially normal to a plane in which the plurality of orifices are arranged.

4. The apparatus according to claim 2, wherein the actuator is displaced in a direction substantially parallel to a plane in which the plurality of orifices are arranged.

5. The apparatus according to claim 1, comprising a plurality of piezoelectric actuators.

6. The apparatus according to claim 5, wherein the body comprises a plurality of cavities and wherein at least on of the plurality of actuators is selectively coupled to pressurize the fluid within each cavity.

7. The apparatus according to claim 1, wherein the orifices are sized to produce fluid droplets having a diameter of from about 5 μm to about 250 μm.

8. The apparatus according to claim 1, wherein the apparatus is operable to deliver a fluid flow rate of less than or equal to about 200 μl/s.

9. The apparatus according to claim 1, wherein the apparatus is operable to deliver temporal control of greater than or equal to about 5 μs.

10. A dispensing system comprising:
a fluid supply;
means for applying a voltage pulse to an actuator; and
a fluid dispensing apparatus comprising a body having at least one cavity therein; at least one fluid inlet for introducing the fluid into the cavity and at least one fluid outlet for discharging the fluid from the cavity; a plurality of orifices in communication with the fluid outlet; and at least one piezoelectric actuator selectively coupled to the body and operable to pressurize the fluid within the cavity and permit controlled discharge of the fluid through the plurality of orifices.

11. The system according to claim 10, comprising a plurality of piezoelectric actuators.

12. The system according to claim 11, wherein the body comprises a plurality of cavities and wherein at least one of the plurality of actuators is selectively coupled to pressurize the fluid within each cavity.

13. An fluid jet printhead for applying developer to a photographic element, comprising:
a body having at least one cavity therein;
at least one fluid inlet for introducing a developer into the cavity and at least one fluid outlet for discharging the developer from the cavity;
a plurality of orifices in communication with the fluid outlet; and
at least one piezoelectric actuator selectively coupled to the body and operable to pressurize the developer within the cavity and permit controlled discharge of the developer through the plurality of orifices onto a photographic element.

14. The fluid jet printhead according to claim 13, comprising two fluid inlets wherein the fluid inlets are located at opposite ends of the fluid cavity.

15. The fluid jet printhead according to claim 13, wherein the actuator comprises a piezoelectric material bonded to a metal diaphragm.

16. The fluid jet printhead according to claim 15, wherein the actuator is displaced in a direction substantially normal to a plane in which the plurality of orifices are arranged.

17. The fluid jet printhead according to claim 15, wherein the actuator is displaced in a direction substantially parallel to a plane in which the plurality of orifices are arranged.

18. The fluid jet printhead according to claim 13, comprising a plurality of piezoelectric actuators.

19. The fluid jet printhead according to claim 13, wherein the orifices are sized to produce developer droplets having a diameter of from about 5 μm to about 250 μm.

20. The fluid jet printhead according to claim 13, wherein the printhead is operable to deliver a fluid flow rate of less than or equal to about 200 μl/s.

21. The fluid jet printhead according to claim 13, wherein the apparatus is operable to deliver temporal control of greater than or equal to about 5 μs.

22. The fluid jet printhead according to claim 13, wherein the printhead is operable to provide linear coverage on a substrate of less than or equal to about 100 mm.

23. A dispensing system for applying developer to a photographic element for use in digital film processing comprising:
a developer supply;
means for applying a voltage pulse to an actuator; and
an fluid jet printhead comprising a body having at least one cavity therein; at least one fluid inlet for introducing the developer into the cavity and at least one fluid outlet for discharging the developer from the cavity; a plurality of orifices in communication with the fluid outlet; and at least one actuator selectively coupled to the body and operable to pressurize the developer within the cavity and permit controlled discharge of the developer through the plurality of orifices onto a photographic element.

24. The system according to claim 23, wherein the actuator comprises a piezoelectric material bonded to a diaphragm.

25. The system according to claim 23, comprising a plurality of piezoelectric actuators.

26. The system according to claim 23, wherein the printhead is operable to provide linear coverage on a substrate of less than or equal to about 100 mm.

27. A method for applying developer fluid to a photographic element comprising the steps of:
providing a source of developer fluid, a fluid cavity in communication with the fluid source, and a plurality of orifices in communication with the fluid cavity;
selectively applying a voltage pulse to a piezoelectric actuator to pressurize the developer fluid within the cavity and discharge the developer fluid from the cavity through the plurality of orifices; and
depositing the developer fluid exiting the plurality of orifices onto a photographic element.
